(19) United States
(12) Patent Application Publication
(10) Pub. No.: US 2025/0149669 A1
(43) Pub. Date: May 8, 2025

(54) METHOD OF EXTRACTING METAL FROM SALT SOLUTION DERIVED FROM SPENT BATTERY

(71) Applicant: SK INNOVATION CO., LTD., Seoul (KR)

(72) Inventors: Yeon Hwa LA, Daejeon (KR); Yong Geal MOON, Daejeon (KR); Tea Young LEE, Daejeon (KR)

(21) Appl. No.: 18/938,280

(22) Filed: Nov. 6, 2024

(30) Foreign Application Priority Data
Nov. 7, 2023 (KR) 10-2023-0153018

(51) Int. Cl. H01M 10/54; C22B 3/00; C22B 4/02; C22B 4/04; C22B 26/12; C22B 47/00

(52) U.S. Cl. CPC H01M 10/54; C22B 4/02; C22B 4/04; C22B 23/04; C22B 26/12; C22B 47/00

(57) ABSTRACT

Proposed is a method of extracting a metal from a salt solution derived from a spent battery, the method including preparing a salt solution derived from a spent battery containing metal ions, preparing a metal extractant mixture including a metal extractant and a metal extractant activator, bringing the metal extractant mixture into contact with the salt solution to produce a complex compound of the metal extractant mixture and the metal, and a first filtrate. The method further comprises recovering the complex compound and the first filtrate and bringing an acid into contact with the complex compound to produce a metal salt, and a second filtrate, recovering the metal salt and the second filtrate, and recovering each of the activator and acid from the first filtrate through electrodialysis.

### CROSS REFERENCE TO RELATED APPLICATION

The present application claims priority to Korean Patent Application No. 10-2023-0153018, filed Nov. 7, 2023, the entire contents of which are incorporated herein for all purposes by this reference.

### BACKGROUND OF THE DISCLOSURE

### 1. Field of the Disclosure

Embodiments of the present disclosure relate to a method of extracting a metal from a salt solution derived from a spent battery.

### 2. Description of the Related Art

Recently, as environmental concerns have emerged as a global issue due to an excessive use of fossil fuels, there is an increasing need for transportation running on eco-friendly alternative fuels rather than fossil fuels. These days, among the various eco-friendly transportation means, the most rapidly distributed one is an electric vehicle that uses electrical energy.

An electric vehicle contains a battery, which is a device for powering the vehicle. Since the maximum capacity of the battery decreases as the battery is used, the lifespan of the battery has been shortened to the extent of from several years to a maximum of about 10 years.

With the rapid distribution of an electric vehicle as described above, the amount of salt waste generated in the battery manufacturing process is accordingly increasing worldwide. The amount of salt waste generated from spent batteries of electric vehicles is also increasing with the increase of the electric vehicles reaching the end of their lifespan.

### SUMMARY OF THE DISCLOSURE

According to embodiments of the present disclosure, a purpose is to provide a method of extracting a metal from a salt solution derived from a spent battery.

Accordingly, in an embodiment, the method includes operation 1 of preparing a salt solution derived from a spent battery containing a metal ion, the metal including one of Mn, Co, Ni, and Li, or any combination thereof; operation 2 of preparing a metal extractant mixture including a metal extractant and a metal extractant activator, the metal extractant activator containing LiOH; operation 3 of bringing the metal extractant mixture into contact with the salt solution to produce a complex compound of the metal extractant mixture and the metal, and a first filtrate; operation 4 of recovering each of the complex compound and the first filtrate; operation 5 of bringing an acid into contact with the complex compound to produce a metal salt and a second filtrate; operation 6 of recovering each of the metal salt and the second filtrate; and operation 7 of recovering each of the metal extractant activator and acid from the first filtrate through electrodialysis.

According to an embodiment, the metal extractant may be an acidic metal extractant containing one of a —POOH functional group, such as D2HEPA (Di-2-ethylhexyl phosphoric acid), Cyanex 272 (Bis(2,4,4-trimethylpentyl) phosphinic acid), PC88A (2-Ethylhexyl phosphonic acid mono-2-ethylhexyl ester), Ionquest 801, and DEHPA (Diethylhexyl phosphoric acid), and a —COOH functional group, such as Versatic® 10 (Neodecanoic Acid), Naphthenic Acid, and LIX 860, or any combination thereof.

According to a further embodiment, in the operation 2, the metal extractant activator may be mixed in an amount of 0.2 to 1.0 mol per 1 mol of the metal extractant.

According to a further embodiment, in the operation 3, the metal extractant mixture may be added in an amount of 2.0 to 4.0 mol per 1 mol of the metal ion in the salt solution.

According to yet another embodiment, in the operation 5, the acid may be sulfuric acid.

According to yet another embodiment, in the operation 5, the acid may be added in an amount of 1.0 to 2.0 mol per 1 mol of the complex compound.

According to yet another embodiment, in the operation 7, the electrodialysis may be performed using one of a bipolar membrane, a cation exchange membrane, and an anion exchange membrane, or any combination thereof.

According to yet another embodiment, the method may further include returning the recovered metal extractant activator to the operation 2.

According to yet another embodiment, the acid recovered in the operation 7 may be returned to the operation 1.

According to yet another embodiment, the method may further include removing impurities contained in the first filtrate and then recovering each of the metal extractant activator and acid through electrodialysis.

According to yet another embodiment, the impurity removal may be performed by one of precipitation, adsorption, oxidation, and ion exchange, or any combination thereof.

According to an embodiment of the present disclosure, a valuable metal can be recovered from a salt solution derived from a spent battery while minimizing the occurrence of salt waste, thereby suppressing environmental pollution.

### BRIEF DESCRIPTION OF THE DRAWINGS

FIG. 1 shows a process flow diagram of a method of extracting a metal from a salt solution derived from a spent battery according to an embodiment of the present disclosure;

FIG. 2 shows adding a metal extractant mixture to a salt solution according to a further embodiment of the present disclosure; and a chemical reaction equation by which a reaction occurs in adding of an acid to the complex compound; and

FIG. 3 shows a schematic diagram of performing electrodialysis according to yet another embodiment of the present disclosure.

### DESCRIPTION OF THE EMBODIMENTS

Hereinafter, embodiments of the present disclosure will be described in detail with reference to the attached drawings. However, this is merely illustrative, and the present disclosure is not limited to the specific embodiments explained illustratively.

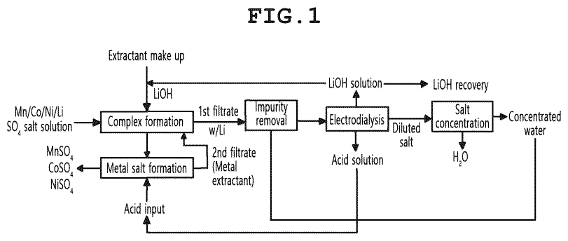

Referring to FIG. 1, a method of extracting a metal from a salt solution derived from a spent battery according to an embodiment of the present disclosure is described.

The method includes operation 1 of preparing a salt solution derived from a spent battery containing a metal ion, the metal including one of Mn, Co, Ni, Li, or any combination thereof. The salt solution derived from a spent battery refers to the salt solution derived in the pretreatment process for recovering reusable metal parts from the spent battery after the battery has reached its end of the lifespan. The salt solution may be derived from the spent lithium battery in a valuable metal recovery process, the spent lithium battery containing, for example, one of Ni, Co, Mn, Li, or any combination thereof. More specifically, the spent lithium battery may comprise LiCoO₂ (LCO), LiFePO₄ (LFP), LiMn₂O₄ (LMO), LiNiMnCoO₂ (NMC), LiNiCoAO₂ (NCA), LiMnO₂, LiSOCl₂, LiFeS₂, or combinations thereof. Specifically, the pretreatment process may be a process of recovering black powder containing a positive electrode active material from scrap of a spent battery and then treating the black powder with an acid to generate a salt solution containing a metal ion. The salt solution prepared in this way is the salt solution derived from the spent battery. The salt solution contains the metal ion derived from the metal in the positive electrode active material of the spent battery. As described above, when the positive electrode active material contains one of Ni, Co, Mn, and Li, or any combination thereof, the metal may include one of Mn, Co, Ni, and Li, or any combination thereof. Additionally, the salt solution derived from the spent battery may also include an ion derived from the acid used in the pretreatment process. For example, SO₄²⁻ ion derived from the acid may be included when sulfuric acid is used in the pretreatment process. Referring to FIG. 1, the salt solution from a spent battery is represented as a Mn/Co/Ni/Li and SO₄ salt solution.

The method includes operation 2 of preparing a metal extractant mixture including a metal extractant and a metal extractant activator, the metal extractant activator containing LiOH. The metal extractant is a compound activated through a reaction with the metal extractant activator. A reaction of the activated metal extractant with the metal ion in the salt solution derived from the spent battery forms a complex compound. The metal extractant activator is a compound that activates a functional group of the metal extractant. In the embodiments of the present disclosure, the metal extractant activator includes LiOH, and specifically, the metal extractant activator may be LiOH. The metal extractant activator is mixed with the metal extractant to form a metal extractant mixture. In a metal extractant mixture, the metal extractant has its functional group activated through a reaction with the metal extractant activator. As described above, the method does not use a compound containing a Na⁺ ion, such as NaOH, as a metal extractant activator, so the first filtrate thereafter does not contain Na. Accordingly, the method does not require processes such as evaporation, crystallization, washing, and/or recrystallization to recover and purify a Li salt from a Na₂SO₄-containing solution and does not produce a compound such as Na₂SO₄ as a by-product.

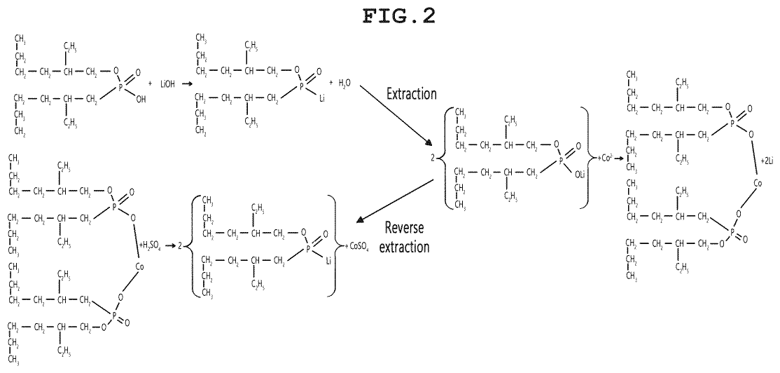

According to a further embodiment, the metal extractant may be an acidic metal extractant containing one of a —POOH functional group, and —COOH functional group, or any combination thereof. The acidic metal extractant containing the −POOH functional group and/or −COOH functional group is used to extract a metal such as Mn, Co, or Ni from the salt solution. As shown in FIG. 2, the metal extractant containing the —POOH functional group is activated by replacing H at the end of the functional group with Li through an acid-base reaction with a metal extractant activator (e.g., LiOH), and then the activated metal extractant may be used to extract the metal contained in the salt solution by producing a complex compound with the metal ion (Co²⁺) in the salt solution.

According to yet another embodiment, in the operation 2, the metal extractant activator may be mixed in an amount of 0.2 to 1.0 mol per 1 mol of the metal extractant. As shown in FIG. 2, the metal extractant often contains one functional group per molecule, and thus one molecule of the metal extractant reacts with one molecule of the metal extractant activator for its activation. When the metal extractant activator is mixed in an amount of less than 0.2 mol per 1 mol of metal extractant in operation 2, the metal extractant may not be activated smoothly. When the metal extractant activator is mixed in an amount exceeding 1.0 mol per 1 mol of metal extractant, it may adversely affect metal extraction efficiency by increasing the pH of the salt solution. According to yet another embodiment, in the operation 2, the metal extractant activator may be mixed in an amount of 0.4 to 0.8 mol or 0.5 to 0.6 mol per 1 mol of the metal extractant.

The method includes an operation 3 of forming a complex compound by bringing the metal extractant mixture into contact with the salt solution to produce a complex compound of the metal extractant mixture and the metal, and a first filtrate. This is indicated as a “complex formation” in FIG. 1. In operation 3, two molecules of the activated metal extractant included in the metal extractant mixture come in contact with one divalent metal ion in the salt solution to produce a complex compound. The remaining components of the salt solution, that did not involve producing a complex compound, are included in the first filtrate. The complex compound is in an oil phase, and the first filtrate is in a water phase, and the complex compound and first filtrate are phase-separated by density difference.

According to yet another embodiment, in the operation 3, the metal extractant mixture may be added in an amount of 2.0 to 4.0 mol per 1 mol of the metal ion in the salt solution. As shown in FIG. 2, the metal ion in the salt solution mainly has an oxidation number of +2, and reacts with two molecules of the activated metal extractant to produce a complex compound. In the operation 3, when the metal extractant mixture is added in an amount of less than 2.0 mol per 1 mol of metal ion in the salt solution, a large amount of the metal ion that do not participate in the reaction for the complex compound formation may remain in the salt solution, reducing the efficiency of metal extraction. In the operation 3, when the metal extractant mixture is added in excess of 4.0 mol per 1 mol of the metal ion in the salt solution, the excess metal extractant mixture will not react with the metal ion and will remain, making it uneconomical. In yet another embodiment, in the operation 3, the metal extractant mixture may be added in an amount of preferably 2.0 to 3.0 mol, or 2.2 to 2.5 mol, per 1 mol of the metal ion in the salt solution. More preferably, the metal extractant mixture may be added on a molar basis according to a pH isotherm curve of a target metal to be extracted.

The method includes operation 4 of recovering each of the complex compound and the first filtrate. The complex compound and first filtrate are recovered separately from each other, and each undergoes separate processing as described later.

The method includes operation 5 of a metal salt formation by bringing an acid into contact with the complex compound to produce a metal salt, and a second filtrate. This is indicated as the “metal salt formation” in the process schematic of FIG. 1. When the complex compound and acid come into contact, as shown in FIG. 2, the bond between the functional group portions of the metal extractant in the complex compound and the metal ion is broken, and the metal extractant is regenerated. At the same time, the metal ion is converted to the form of a metal salt. The metal salt is dissolved in an aqueous solution (water phase) and is recovered by phase-separation from the second filtrate in an oil phase due to density difference. As shown in FIG. 2, the second filtrate contains a metal extractant regenerated by binding the functional group portions of the metal extractant in the complex compound with the H⁺ ion of the acid.

In an embodiment, the acid in the operation 5 may be one of sulfuric acid, nitric acid, hydrochloric acid, or any combination thereof. The acid added to the complex compound is not limited as long as the acid helps to regenerate the metal extractant and allow the metal in the salt solution to be recovered in the form of a metal salt. From the viewpoint of allowing the metal in the salt solution to be recovered in the form of metal sulfate, which is a raw material for manufacturing a battery precursor, the acid is preferably sulfuric acid. In addition, the sulfuric acid may be cheaper than other strong acids in terms of cost.

According to yet another embodiment, in the operation 5, the acid may be added in an amount of 1.0 to 2.0 mol per 1 mol of the complex compound. As shown in FIG. 2, when the acid in contact with the complex compound in the operation 5 is the sulfuric acid, one molecule of the sulfuric acid destroys the bonds between two metal extractant functional groups and one metal ion present in the complex compound, forming two molecules of metal extractant and one molecule of metal salt. In the operation 5, when the acid is added in an amount of less than 1.0 mol per mol of the complex compound in the complex compound, only a portion of the bonds between the metal extractant functional groups and metal ion in the complex compound may be destroyed, thus only a smaller amount of molecules than the desired amount remain. This may result in a reduction in a recovered metal salt amount. In the operation 5, when the acid is added in an amount exceeding 2.0 mol per 1 mol of the complex compound in the complex compound, the pH of the aqueous solution containing the metal salt is lowered due to the excess acid, leading to equipment constraints in the subsequent metal salt concentration and crystallization. According to yet another embodiment, in the operation 5, the acid may be added in an amount of preferably 1.0 to 1.5 mol, more preferably 1.0 to 1.2 mol, per 1 mol of the complex compound in the complex compound.

The method includes one or more operations generally designated as operation 6 of recovering each of the metal salt and the second filtrate. The metal salt recovered here may be reused as raw material for manufacturing a battery precursor through separate concentration/crystallization and purification processes. The recovered second filtrate may be returned to the operation 3. In the operation 3, the metal extractant in the recovered second filtrate may be activated through a reaction with the metal extractant activator in the metal extractant mixture, and then participate in the reaction of the complex compound formation.

The method includes operation 7 of recovering each of the metal extractant activator and acid from the first filtrate using electrodialysis. This is indicated as the “electrodialysis” in FIG. 1. The operation 7 of recovering each of the metal extractor activator and acid recovery using electrodialysis involves decomposing the water component of the first filtrate into H⁺ and OH⁻ by applying power between two electrodes and then binding these ions with ionic components or salts present in the first filtrate, for example, Li₂SO₄ to recover a binding product in acid and base form. The base recovered in the electrodialysis is the metal extractant activator. Any suitable electrodialysis device may be used without limitation as long as the device may recover an acid and base from the first filtrate. The salt at a high concentration in the salt solution derived from the spent battery is separated in the electrodialysis and recycled as an acid and base, and thus the salt solution is partially desalted. Some desalted salt solution (demineralized water) is referred to as “diluted salt” in FIG. 1. The diluted salt is concentrated in an operation referred to as “Salt Concentration” in FIG. 1 to the salt concentration level before executing the electrodialysis (“concentrated water” shown in FIG. 1), and the concentrated water may be returned to the electrodialysis.

In an embodiment, the recovering of each of the metal extractant activator and acid using electrodialysis may be performed by one of a bipolar membrane (BPM), a cation exchange membrane (CEM), and an anion exchange membrane (AEM), or any combination thereof. The cation exchange membrane is a membrane made of a polymer layer that allows only a positive ion to pass through. The anion exchange membrane is a membrane made of a polymer layer that allows only an anion to pass through. The bipolar membrane is a membrane of two polymer layers overlapped, each of which allows corresponding positive ion and anion to pass through. In yet another embodiment, the electrodialysis may be performed using a bipolar membrane.

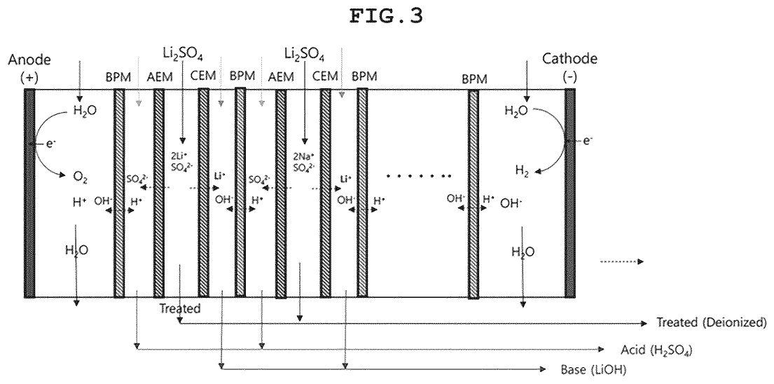

Referring to FIG. 3, the recovering of each of the metal extractant activator and acid using the electrodialysis is schematically depicted. After water is decomposed into H⁺ and OH at the interface between the cation-permeable polymer layer and anion-permeable polymer layer of the bipolar membrane, OH⁻ binds with a Lit ion generated by decomposition of Li₂SO₄ salt to produce a base (LiOH), and to produce an acid (H₂SO₄), H⁺ binds with SO₄²⁻ ion generated by decomposition of Li₂SO₄ salt. In an existing membrane process, membrane-permeable substances are selective. In a process using a bipolar membrane, the electrolysis reaction of water occurs at the interface between the cation-permeable polymer layer and anion-permeable polymer layer, rather than on the electrode surface. For this reason, in the bipolar membrane, electrodialysis is performed by installing electrodes only at both ends of the membrane stack without the need to install electrodes between each membrane. Since electrodialysis is performed even at a lower voltage, the bipolar membrane is advantageous in reducing device design and device operation costs.

According to yet another embodiment, the method may further include operation 8 of returning the recovered metal extractant activator to the operation 2. As described above, the first filtrate introduced into electrodialysis contains Lit, which is an ion remaining after the activation reaction of the metal extractant. To be converted into a metal extractant activator (LiOH), the Li⁺ reacts with OH generated by electrolysis of water. The metal extractant activator thus produced is the same as the metal extractant activator used in the operation 2 of preparing a metal extractant mixture, and the metal extractant activator may be recovered and returned to the operation 2. The returned metal extractant activator may activate the functional group of the metal extractant in the same way as the existing metal extractant activator. The returned metal extractant activator may be used to activate the metal extractant after undergoing concentration, if necessary.

In yet another embodiment, the recovered acid may be returned to the operation 1 of preparing a salt solution derived from a spent battery containing a metal ion. The anion is one which constitutes the acid recovered in the electrodialysis, and the anion is derived from the acid added in the pretreatment process to prepare a salt solution by leaching the metal in the operation 1. For example, when an acid added in the pretreatment process of the operation 1 is H₂SO₄, SO₄²⁻ ion is included in the first filtrate and are introduced into the recovering of each of the metal extractant activator and acid using electrodialysis in the operation 7. In the recovering of each of the metal extractant activator and acid using electrodialysis, SO₄²⁻ ion binds with H⁺ generated by electrolysis of water and are recovered as H₂SO₄, which is the same as the acid added in the operation 1. Therefore, the acid recovered using electrodialysis may be returned to the operation 1 and used for pretreatment to prepare a salt solution by leaching the metal.

According to yet another embodiment, the method may further include removing an impurity contained in the first filtrate, and then recovering each of the metal extractant activator and acid using electrodialysis. This is indicated as the “Impurity Removal” operation in the process schematic of FIG. 1. The first filtrate may contain an impurity from the operations 1 to 5 in addition to the Lit ion from the metal extractant activator and anion from the acid (for example, SO₄²⁻) from the operation 5. Herein, “impurity” refers to a substance in the aqueous phase other than the components constituting the acids and bases recovered by electrodialysis in the operation 7. The impurity includes, for example, a metal extractant dissolved in small amounts in the first filtrate in the operation 3, the complex compound, and a Lit-excluded metal ion that remains and may not be recovered in the form of a metal salt. There is no limit to the impurity removal method as long as the impurity may be removed.

According to yet another embodiment, the impurity removal may be performed by one of precipitation, adsorption, oxidation, and ion exchange, or any combination thereof. The precipitation may include coagulation precipitation. The coagulation precipitation is a process of separating an impurity in the first filtrate from the treatment liquid through impurity precipitation by adding a chemical coagulant or coarsening the impurity in electrocoagulation. More specifically, the coagulation precipitation involves adding a chemical coagulant or eluting metal ion from the electrode to form a hydroxide of the metal ion and involves forming an aggregate through a coagulation reaction between the hydroxide and impurity in the first filtrate. Herein, the aggregate refers to a substance of the impurity in the first filtrate aggregated by electric coagulation. The treatment liquid refers to a liquid component after the aggregate is separated from the first filtrate.

The precipitation process after coagulation is a process of separating and removing the aggregate from the treatment liquid by density difference between the treatment liquid and the aggregate in the first filtrate. In yet another embodiment, the precipitation may be performed by known means for separating the aggregate from the treatment liquid. For example, the precipitation may be performed by known means such as a sedimentation tank and a skimmer. After the precipitation process, the aggregate separated from the treatment liquid may be discarded or introduced into further treatments, and the treatment liquid may be subjected to electrodialysis.

The adsorption is a process of removing the impurity in the first filtrate by adsorbing the impurity with an adsorbent. Any suitable method of adsorption may be used provided the method may separate the treatment liquid from the impurity. As an example, the adsorption method may be performed through filtration using a filter containing an adsorbent. The adsorbent type is also not limited as long as the adsorbent may adsorb the impurity. An example of a suitable adsorbent is activated carbon.

The oxidation process may be performed using chemicals. For example, the oxidation may include a process using Fenton oxidation, which generates hydroxyl radicals (OH radicals through a catalytic reaction between the impurity and hydrogen peroxide or using ozone oxidation, which injects ozone. In addition, any process that oxidizes and removes harmful substances through an oxidation reaction may be used without limitation.

The ion exchange process is a process for separating a remaining polyvalent metal ion from the treatment liquid. In the ion exchange process, the polyvalent metal ions are precipitated in a salt form and separated from the treatment liquid by adding an ion exchange washing solution.

The present disclosure has been described in detail above through specific embodiments. The embodiments are for specifically describing the scope of the present disclosure, and embodiments of the present disclosure are not limited thereto. It should be clear that modifications and improvements may be made by those skilled in the art within the technical scope of the present disclosure and the claims. The embodiments may be combined to form additional embodiments.

All simple modifications or changes to the present disclosure fall within the scope of the present disclosure, and the specific scope of protection of the present disclosure will be made clear by the appended claims.

What is claimed is:

1. A method of extracting a metal from a salt solution derived from a spent battery, the method comprising:
operation 1 of preparing a salt solution derived from a spent battery containing a metal ion of one of metals comprising Mn, Co, Ni, and Li, or any combination thereof;
operation 2 of preparing a metal extractant mixture including a metal extractant and a metal extractant activator;
operation 3 of bringing the metal extractant mixture into contact with the salt solution to produce a complex compound of the metal extractant mixture and the metal, and a first filtrate;
operation 4 of recovering each of the complex compound and the first filtrate;
operation 5 of bringing an acid into contact with the complex compound to produce a metal salt, and a second filtrate;
operation 6 of recovering each of the metal salt and the second filtrate; and
operation 7 of recovering each of the metal extractant activator and acid from the first filtrate through electrodialysis.

2. The method of claim 1, wherein the metal extractant activator contains LiOH, and
wherein the metal extractant is an acidic metal extractant comprising one of a —POOH functional group, and a —COOH functional group, or any combination thereof.

3. The method of claim 1, wherein, in the operation 2, the metal extractant activator is mixed in an amount of 0.2 to 1.0 mol per 1 mol of the metal extractant.

4. The method of claim 1, wherein, in the operation 3, the metal extractant mixture is added in an amount of 2.0 to 4.0 mol per 1 mol of the metal ion in the salt solution.

5. The method of claim 1, wherein, the acid in the operation 5 is sulfuric acid.

6. The method of claim 5, wherein, in the operation 5, the acid is added in an amount of 1.0 to 2.0 mol per 1 mol of the complex compound.

7. The method of claim 1, wherein, in the operation 7, electrodialysis is performed using a bipolar membrane, a cation exchange membrane, an anion exchange membrane, or any combination thereof.

8. The method of claim 1, further comprising returning the recovered metal extractant activator to the operation 2.

9. The method of claim 1, wherein, in the operation 7, the acid is returned to the operation 1.

10. The method of claim 1, further comprising removing an impurity in the first filtrate before recovering each of the metal extractant activator and the acid through the electrodialysis.

11. The method of claim 10, wherein the impurity removal is performed by one of precipitation, adsorption, oxidation, and ion exchange, or any combination thereof.

12. A method of extracting a metal from a salt solution derived from a spent battery, the method comprising:
preparing a salt solution derived from a spent battery containing a metal ion;
reacting the activated metal extractant with the metal ion of the salt solution to form a complex compound;
recovering the complex compound and contacting the complex compound with an acid to produce a metal salt; and
recovering the metal salt.

13. The method of claim 12, wherein the activated metal extractant is prepared by contacting a metal extractant with a metal extractant activator.

14. The method of claim 12, wherein the reacting the activated metal extractant with the metal ion of the salt solution includes bringing the metal extractant mixture into contact with the salt solution to produce the complex compound of the metal extractant mixture and the metal, and a first filtrate.

15. The method of claim 14, further comprising recovering the complex compound and the first filtrate.

16. The method of claim 15, wherein the contacting the complex compound with the acid to produce the metal salt also produces a second filtrate.

17. The method of claim 16, further comprising recovering the second filtrate, and each of the activator and acid from the first filtrate through electrodialysis.
